(19) United States
(12) Patent Application Publication
(10) Pub. No.: US 2025/0237770 A1
(43) Pub. Date: Jul. 24, 2025

(54) HIGH ENERGY RADIATION DETECTORS

(71) Applicant: University of Kansas, Lawrence, KS (US)

(72) Inventors: Judy Z. Wu, Lawrence, KS (US); Maogang Gong, Lawrence, KS (US)

(21) Appl. No.: 18/699,376

(22) PCT Filed: Oct. 10, 2022
(86) PCT No.: PCT/US2022/077834

§ 371 Date: Apr. 8, 2024

(51) Int. Cl. G01T 1/202

(52) U.S. Cl. CPC G01T 1/2023

(57) ABSTRACT

Methods for detecting high energy radiation are provided, including those comprising exposing a detector to a source of high energy radiation, the detector comprising a scintillator layer comprising a metal halide perovskite; a charge generation layer comprising semiconductor quantum dots, the charge generation layer positioned between the scintillator layer and a charge transport layer comprising graphene, the charge generation layer forming an interface with the charge transport layer: the charge transport layer comprising graphene; and electrodes in electrical communication with the charge transport layer. The methods further comprise collecting carriers from the charge transport layer, the carriers generated in the charge generation layer via absorption of the high energy radiation in the scintillator layer. The high energy radiation detectors are also provided.

### CROSS-REFERENCE TO RELATED APPLICATIONS

The present application claims priority to U.S. Provisional Patent Application No. 63/254,281 that was filed Oct. 11, 2021, the entire disclosure of which is hereby incorporated by reference.

### BACKGROUND

X-ray detectors are used in various applications including medical imaging, security screening, industrial inspection, etc. Although metal halide perovskites (MHPs) have been used as the active layer in some X-ray detectors, it remains challenging to obtain a high μt product (μ is the charge carrier mobility and τ is the charge carrier lifetime) in MHP layers, due to the presence of various charge trapping mechanisms associated with growth defects, grain boundaries, surface states, etc., which significantly reduce the carrier mobility μ.

### SUMMARY

The present disclosure provides detectors based on heterostructures comprising graphene, semiconductor quantum dots, and metal halide perovskites. Advantages of the detectors include one or more of extremely high sensitivities (e.g., ˜2×10³ C/Gy·cm², which in units of μC, corresponds to 2×10⁹ μC/Gy·cm²), flexibility (allowing for curved and conformal detectors), and scalability. The detectors may be used to detect high energy radiation, e.g., X-rays, gamma rays, α-particles, etc., even at very low intensities, e.g., single photons/particles. The sensitivities to X-rays, for example, of the detectors are several orders of magnitude higher than existing X-ray photodetectors based on metal halide perovskite single crystals, nanocrystals, and polycrystalline films. For example, an existing X-ray photodetector based on CsPbBr₃ was reported to have a sensitivity of 1.45×10³ μC/Gy·cm². (Liu, Jingying, et al. Advanced Materials 31.30 (2019): 1901644.) Since 1 C=10⁶ μC, this corresponds to a sensitivity of 1.45×10³ C/Gy·cm², a sensitivity which is orders of magnitude lower than the present detectors.

Methods for detecting high energy radiation are provided. In embodiments, such a method comprises exposing a detector to a source of high energy radiation, the detector comprising a scintillator layer comprising a metal halide perovskite: a charge generation layer comprising semiconductor quantum dots, the charge generation layer positioned between the scintillator layer and a charge transport layer comprising graphene, the charge generation layer forming an interface with the charge transport layer: the charge transport layer comprising graphene; and electrodes in electrical communication with the charge transport layer. The method further comprises collecting carriers from the charge transport layer, the carriers generated in the charge generation layer via absorption of the high energy radiation in the scintillator layer.

The high energy radiation detectors are also provided. In embodiments, such a detector comprises a scintillator layer comprising a metal halide perovskite: a charge generation layer comprising semiconductor quantum dots, the charge generation layer positioned between the scintillator layer and a charge transport layer comprising graphene, the charge generation layer forming an interface with the charge transport layer; the charge transport layer comprising graphene; and electrodes in electrical communication with the charge transport layer.

Other principal features and advantages of the disclosure will become apparent to those skilled in the art upon review of the following drawings, the detailed description, and the appended claims.

### BRIEF DESCRIPTION OF THE DRAWINGS

Illustrative embodiments of the disclosure will hereafter be described with reference to the accompanying drawings.

FIG. 1A shows a schematic of a PMMA/PbS QDs/graphene detector. FIG. 1B shows a scaled-up version of a portion of the detector of FIG. 1A. The arrow represents high energy radiation (e.g., X-rays). FIG. 1C shows a schematic of a PMMA/CsPbCl₃ NCs/PMMA/PbS QDs/graphene detector. FIG. 1D shows a scaled-up version of a portion of the detector of FIG. 1C. The arrow represents X-ray radiation high energy radiation (e.g., X-rays).

FIGS. 2A-2B show UV-visible absorbance spectra of CsPbCl₃ NCs and PbS QDs, respectively. FIGS. 2C-2D show the corresponding TEM images of the CsPbCl₃ NCs and PbS QDs, respectively.

FIG. 3A shows a schematic of an X-ray characterization system comprising a detector according to the present disclosure, e.g., the detectors of FIG. 1A or FIG. 1C. FIG. 3B shows a schematic of a top view of an illustrative detector similar to that of FIG. 1C, but in the form of a detector array including a plurality of electrodes in electrical communication with an overlying graphene layer, providing a plurality of graphene channels, each channel formed between adjacent electrodes and having a width of 866 μm. (Not shown are the PbS QDs or the PbS QDs/CsPbCl₃ NCs.) FIG. 3C shows the dynamic X-ray response of two illustrative detector arrays, one based on PbS QDs/graphene, and one based on CsPbCl₃ NCs/PbS QDs/graphene.

FIG. 4A is a schematic depiction of the X-ray down-conversion to visible-infrared light in the layer of MHP-NCs, followed by detection of the visible-infrared light by the QDs/graphene layers in an illustrative PMMA/CsPbCl₃ NCs/PMMA/PbS QDs/graphene X-ray detector. FIG. 4B plots the sensitivity of a PMMA/PbS QDs/graphene detector and three PMMA/CsPbCl₃ NCs/PMMA/PbS QDs/graphene detectors. The sensitivity was measured using the X-ray characterization system of FIG. 3A.

FIG. 5A plots the I-V curves of a PMMA/CsPbCl₃ NCs/PMMA/PbS QDs/graphene X-ray detector on a PET substrate in the dark and under X-ray irradiation. FIG. 5B shows a zoomed-in portion of FIG. 5A. FIG. 5C is a schematic view of an array of PMMA/CsPbCl₃ NCs/PMMA/PbS QDs/graphene X-ray detectors on a flexible PET substrate. FIG. 5D plots I-V curves before bending the detector array of FIG. 5C and after bending 20 times, demonstrating no difference in the two I-V curves.

### DETAILED DESCRIPTION

Provided are detectors for detecting high energy radiation based on heterostructures of graphene, semiconductor quantum dots, and metal halide perovskites. In embodiments, a high energy radiation detector comprises a scintillator layer comprising or consisting of a metal halide perovskite: a carrier generation layer comprising or consisting of semiconductor quantum dots: a carrier transport layer comprising or consisting of graphene; and electrodes in electrical communication with the carrier transport layer. The carrier generation layer is positioned between the scintillator layer and the carrier transport layer. The carrier generation layer is also in direct contact with the carrier transport layer so as to form an interface therebetween.

The scintillator layer comprises or consists of a metal halide perovskite. The scintillator layer is configured to carry out a scintillation process involving absorption of the high energy radiation (e.g., X-rays) and down conversion of the absorbed radiation to lower energy radiation (e.g., ultraviolet (UV), visible (Vis), or near-infrared (NIR) radiation). The scintillation process is further described in the Example, below. Thus, the composition and morphology of the scintillator layer/metal halide perovskite may be selected to ensure its function as a scintillator.

Specifically, the metal halide perovskite of the scintillator layer may be a compound having Formula I, ABX₃, wherein A and B are cations having different sizes (i.e., ionic radii). One or both of A and B are selected from metals and X is selected from halogens. In embodiments, both A and B are selected from metals. Such metal halide perovskites may be referred to as “all inorganic” metal halide perovskites. At least one of the metals, e.g., B, may be a high Z (atomic number) element such as Pb. In embodiments, the metal halide perovskite has Formula IA, APbX₃, wherein A is selected from alkali metals and X is selected from halogens. In embodiments, the metal halide perovskite has Formula IB. CsPbX₃, wherein X is selected from halogens. Combinations of different types of metal halide perovskites may be used in the scintillator layer.

The formulas above encompass doped or alloyed or mixed metal halide perovskites, i.e., compounds which include more than one type of A cation (e.g., two, three, etc.) in varying relative amounts (provided the sum of the amounts is about 1 atom per a structural A-site), more than one type of B cation (e.g., two, three, etc.) in varying relative amounts (provided the sum of the amounts is about 1 atom per a structural B-site), more than one type of X anion (e.g., two, three, etc.) in varying relative amounts (provided the sum of the amounts is about 3), or combinations thereof. By way of illustration, metal halide perovskites having formula AB(X₁)_{z}(X₂)_{3-z}, wherein z ranges from about 0 to about 1 are encompassed by Formula I.

The formulas above also encompass compounds in which the amounts of the elements (i.e., A, B, X) may deviate from ideal, e.g., non-stoichiometric compounds. For example, the deviation may be up to about 10% in cations (A or B) and up to about 20% in halogens. By way of illustration, this means that the formulas encompass compounds such as ABX_{2.98}, ABX_{2.5}, A_{0.95}BX₃, etc.

The metal halide perovskite of the scintillator layer may assume various forms, including individual, discrete nanocrystals or a film, which may be considered to be a continuous, monolithic structure as opposed to such nanocrystals. Such films may be polycrystalline or single-crystalline. Such nanocrystals may have an average largest cross-sectional dimension that is no greater than 1000 nm. This includes no greater than 500 nm, no greater than 250 nm, no greater than 100 nm, no greater than 50 nm, no greater than 10 nm, or in the range of 1 nm to 500 nm. Due to their crystalline nature, the nanocrystals generally have a faceted shape such as cubic.

The scintillator layer may be characterized by its average thickness taken along the dimension perpendicular to the plane of the layer. The average thickness may be in a range of from 10 nm to 500 nm. This includes from 10 nm to 400 nm, from 10 nm to 300 nm, from 10 nm to 250 nm, from 10 nm to 200 nm, and from 100 nm to 200 nm. If the metal halide perovskite is in the form of nanocrystals, the minimum average thickness may be a monolayer of the nanocrystals. The average thickness may be determined from SEM cross-sectional images of the scintillator layer. It is noted that these average thicknesses are quite thin as compared to absorber layers used in existing X-ray photodetectors. Since the scintillator thickness is proportional to the number of high energy photons/particles captured, the high sensitivities achieved even for relatively thin scintillator layers further underscores the advantages of the present high energy detectors. Even higher sensitivities may be achieved by simply increasing the scintillator thickness.

The carrier generation layer comprises or consists of semiconductor quantum dots. The carrier generation layer is configured to absorb down converted radiation generated by the overlying scintillator layer and to convert the absorbed radiation to carriers (e.g., electrons). Thus, the composition and morphology of the carrier generation layer/semiconductor quantum dots may be selected to ensure this function as well as to achieve a desired (e.g., maximum) carrier lifetime.

Specifically, the semiconductor quantum dots of the carrier generation layer generally comprise a high Z (atomic number) element, such as Pb. Illustrative such semiconductors include PbS, halide metal perovskites (both organic and inorganic). Hg—Cd—Te, WOₓ, and Bi—X (X=Te, Se, S, etc.) Each of the three dimensions of the semiconductor quantum dots are nanoscale so as to facilitate quantum confinement, e.g., 100 nm or less, 50 nm or less. 25 nm or less, 10 nm or less. 5 nm or less, or in a range of from 1 nm to 25 nm. The semiconductor quantum dots may have spherical shapes, but other shapes may be used, e.g., ovoid, faceted shapes such as cubic, etc. The carrier generation layer may be characterized by its average thickness taken along the dimension perpendicular to the plane of the layer. The average thickness may be in a range of from a monolayer (e.g., 3 nm to 50 nm) of the semiconductor quantum dots to 300 nm. This includes from a monolayer to 200 nm and from a monolayer to 150 nm. The average thickness may be determined from scanning electron microscope (SEM) cross-sectional images of the carrier generation layer.

The scintillator layer and the carrier generation layer may be in direct contact with one another, although in other embodiments, another material layer, e.g., a charge blocking material layer may be positioned therebetween. By contrast to some existing detectors, a pn junction is not required or formed between the scintillator layer and the carrier generation layer in the present detectors.

The carrier transport layer comprises or consists of graphene. The carrier transport layer conducts carriers. e.g., electrons, transferred to the carrier transport layer from the overlying carrier generation layer. The graphene of the carrier transport layer is generally a monolayer of graphene. However, the graphene may be a multilayer structure comprising multiple sublayers of graphene, each sublayer corresponding to a monolayer of graphene. The lateral dimensions of the graphene are not particularly limited. The graphene may be “transferred,” which refers to a graphene layer which has been transferred from a growth substrate on which it was grown. The graphene may be “chemical vapor deposition (CVD)-synthesized,” which refers to a graphene layer which has been grown using CVD.

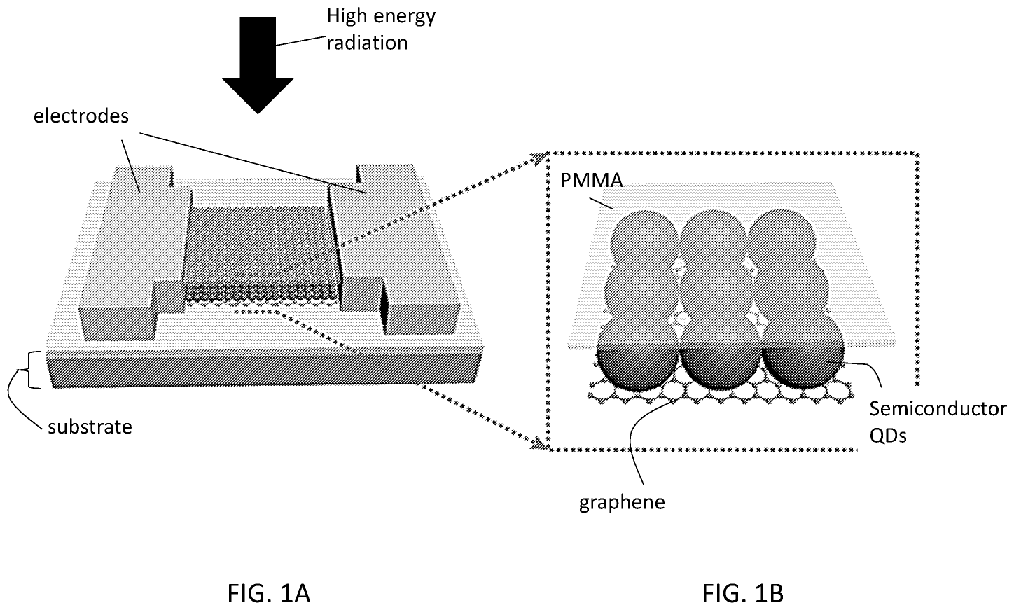

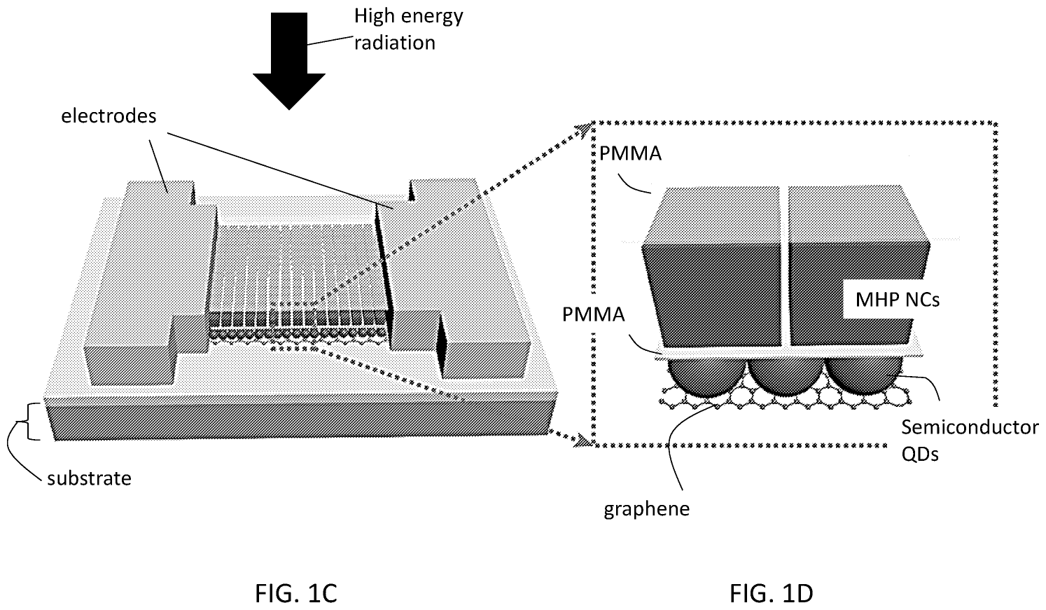

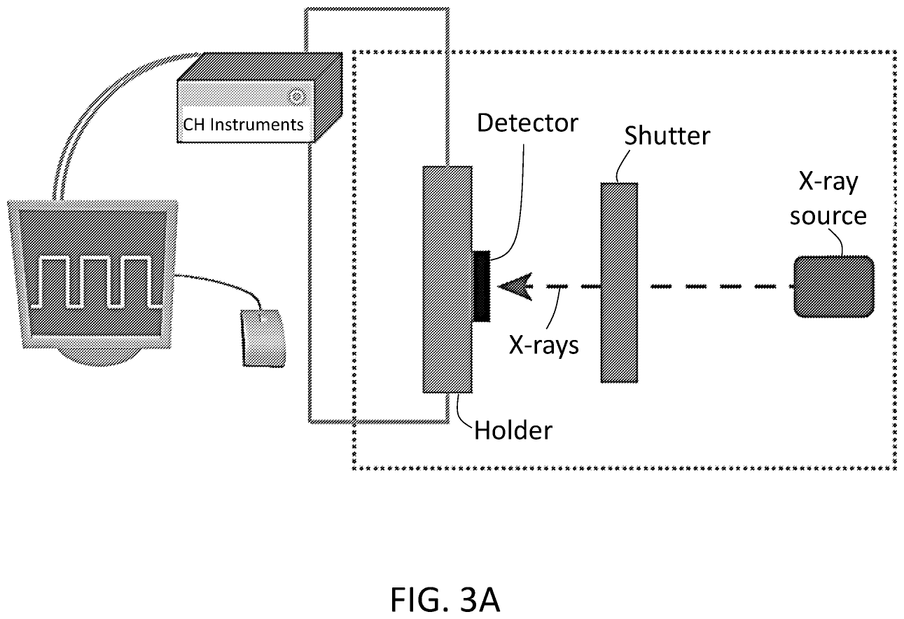

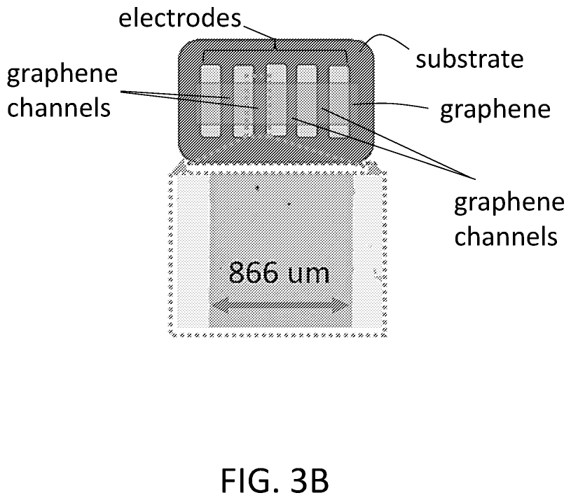

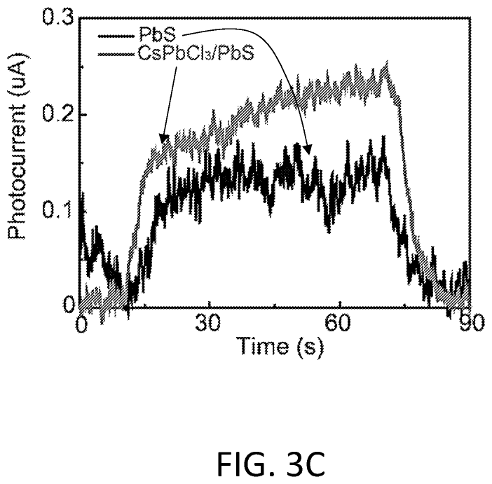

Operation of the present detectors involves collecting carriers (e.g., electrons) generated by the absorption of the high energy radiation by the scintillator layer. Thus, as noted above, the detectors also include electrodes in electrical communication with the charge transport layer. The materials and form of these electrodes are not particularly limited, provided they are capable of collecting the generated carriers. The carriers are collected by application of a bias voltage applied to the electrodes. The electrodes may be deposited spaced apart from one another and directly on the same surface of the carrier transport layer, thereby forming a graphene channel therebetween. (See FIGS. 1A, 1C, 3B.) As further described below, the charge generation layer, may then be deposited on the graphene channel, followed by deposition of the scintillation layer onto the charge generation layer. Two electrodes (i.e., source and drain electrodes) or three (i.e., source, gate, and drain electrodes) may be used.

The present detectors generally assume a horizontal architecture in which the electric field generated by a bias voltage applied to the electrodes is oriented parallel to the planes defined by the material layers of the detector, i.e., the scintillator layer, the carrier generation layer, and the carrier transport layer. (It is noted that the electric field generated by the applied bias voltage is distinguished from the electric field that forms across the interface formed between the charge generation layer and the charge transport layer due to band-edge alignment.) This may be accomplished by using the architectures illustrated in FIGS. 1A and 1C and described above in which the electrodes are formed on the same surface of the carrier transport layer: the scintillator layer and the charge generation layer are positioned between the electrodes. This is by contrast to vertical architectures in which the electric field generated by a bias voltage applied to the electrodes is oriented perpendicular to the planes defined by the material layer of the detector.

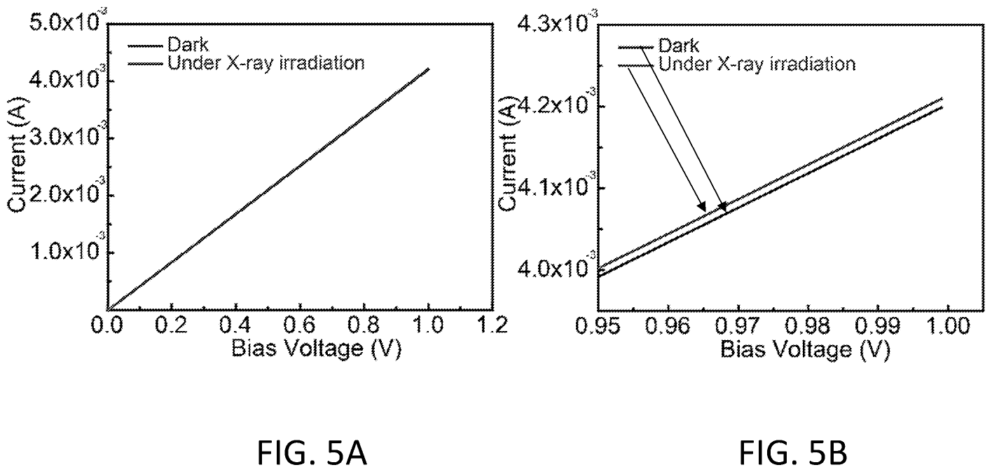

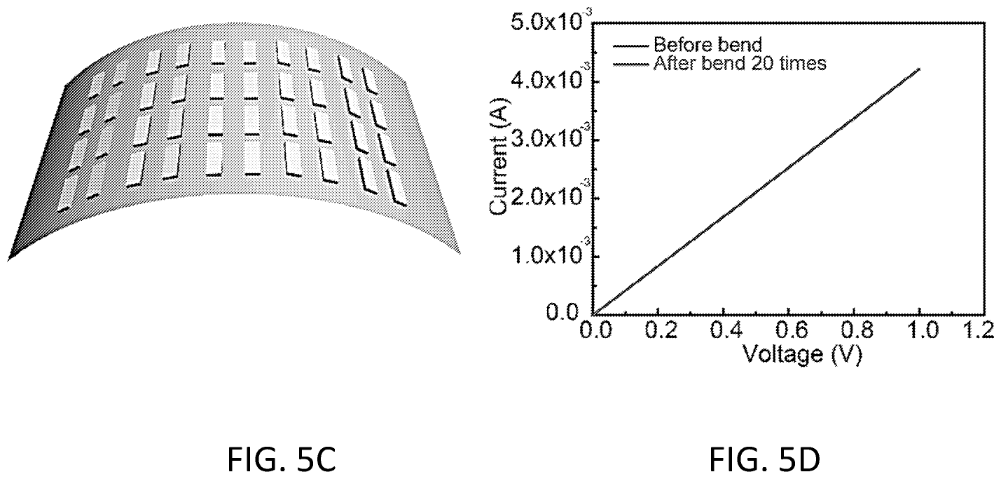

The present detectors may comprise a single active region, which refers to the heterostructure formed by the scintillator layer, the charge generation layer, and the charge transport layer and which is capable of absorbing the high energy radiation to generate carriers which are detected via the two or three electrodes in electrical communication with the charge transport layer. However, the detectors may comprise multiple active regions defined by using a plurality (more than three) of electrodes arranged in an array. (See FIGS. 3B and 5C.) Such detectors may be referred to “detector arrays.” In such detector arrays, some electrodes may be shared between adjacent active regions. Similarly, the carrier transport layer may be shared by different active regions of the detector array.

The present detectors may further comprise a charge blocking material. The composition of this material is one that is capable of blocking the transfer of electrons/holes between the semiconductor quantum dots of the carrier generation layer and the metal halide perovskite of the scintillator layer. Illustrative such materials include poly (methyl methacrylate) (PMMA) and methyl methacrylate (MMA). Other polymers and photoresist materials that are transparent to visible light may be used. The charge blocking material may be in the form of a distinct layer disposed between (including directly between so as to be in direct contact with) the charge generation layer and the scintillator layer. Such a layer of the charge blocking material may be characterized by its average thickness taken along the dimension perpendicular to the plane of the layer. The average thickness may be in a range of from 10 nm to 300 nm, from 10 nm to 250 nm, from 10 nm to 200 nm, and from 10 nm to 150 nm. An additional layer(s) of the charge blocking material may be used, e.g., an uppermost layer of the detector, e.g., deposited on the scintillator layer, to passivate the detector against exposure to the ambient environment.

The heterostructure formed from the scintillator layer, the charge generation layer, and the charge transport layer, as well as the electrodes formed on the charge transport layer, may be formed on an underlying substrate. Various materials may be used for the substrate. e.g., Si/SiO₂. Flexible materials may be used, including polymeric materials such as polyethylene terephthalate (PET).

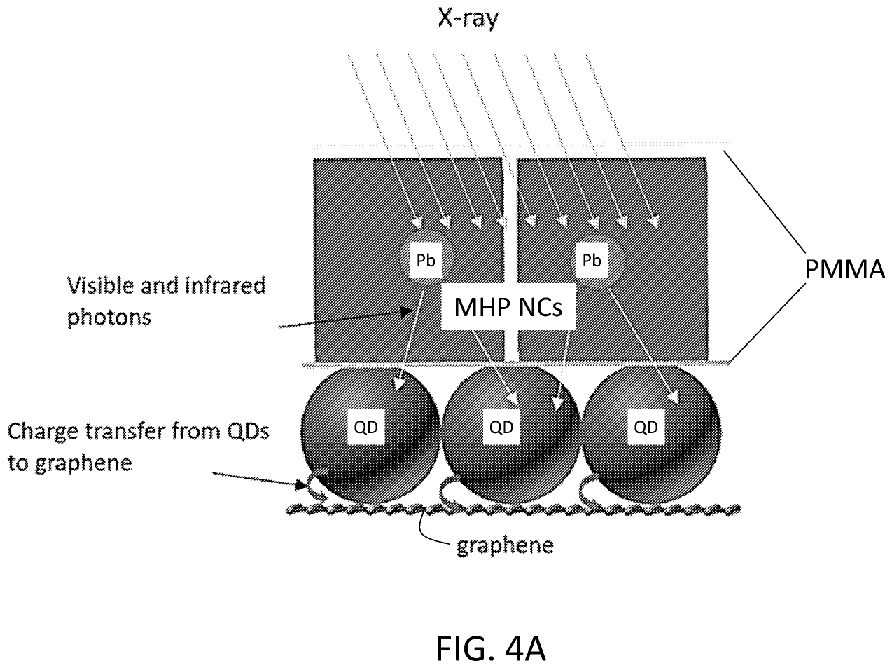

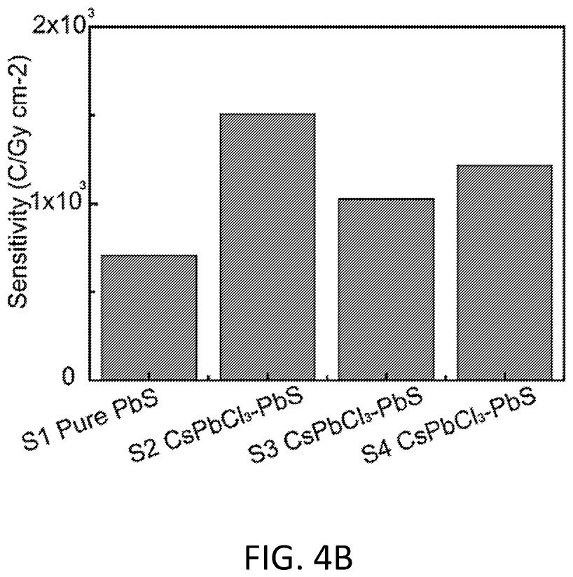

Illustrative embodiments of the present detectors are shown in FIGS. 1A-1D and 4A, and are further described in the Example, below.

In embodiments, the detector comprises or consists of a scintillator layer consisting of one or more types of metal halide perovskites: a charge generation layer consisting of one or more types of semiconductor quantum dots: a charge transport layer consisting of one or more graphene monolayers: electrodes in electrical communication with the charge transport layer; and optionally, one or more layers of a charge blocking material. Any of the metal halide perovskites (e.g., CsPbCl₃ NCs), the semiconductor quantum dots (e.g., PbS QDs), and the charge blocking materials (e.g., PMMA) described herein may be used. In embodiments, the detector may comprise or consist of a single active region consisting of the scintillator layer, the charge generation layer, the charge transport layer, the electrodes, and the optional layer(s) of the charge blocking material. In other embodiments, the detector may be in the form of a detector array comprising or consisting of multiple active regions, each active region consisting of the scintillator layer, the charge generation layer, the charge transport layer, the electrodes, and the optional layer(s) of the charge blocking material. The embodiments in this paragraph (as well as all embodiments of the present disclosure) do not preclude the presence of ligands encapsulating the metal halide perovskites or the semiconductor quantum dots, or the presence of impurities inherent to the processes of synthesizing the materials of the detectors and the processes of fabricating the detectors.

The present detectors may be characterized by various properties, including sensitivity and gain. Sensitivity may be measured as described in the Example, below: In embodiments, the detector has a sensitivity to X-ray radiation of at least 10³ C/Gy·cm². This includes at least 1.5×10³ C/Gy·cm², at least 2×10³ C/Gy·cm², at least 2.5×10³ C/Gy·cm², or at least 3×10³ C/Gy·cm². The Example, below; shows that such sensitivities are unexpectedly large (by orders of magnitude) as compared to X-ray photodetectors which do not include graphene. Gain is the number ratio of the collected carriers from the detector to the incident radiation. In embodiments, the detector has a gain of at least 10⁵, at least 10⁷, or at least 10¹⁰. Such gains are unexpectedly large (by orders of magnitude) as compared to X-ray photodetectors which do not include graphene.

Methods of making the detectors may employ scalable printing techniques such as inkjet deposition. Illustrative details are provided in the Example, below.

Methods of using the detectors may comprise exposing the detector to a source of high energy radiation and collecting generated carriers (e.g., electrons) via a bias voltage applied to the electrodes of the detector. High energy radiation refers to photons or particles having an energy per photon or per particle of at least 1 keV. This includes the energy per photon or per particle being at least 10 keV, at least 100 keV, at least 1 MeV, or at least 10 MeV. The high energy radiation may be X-rays, gamma rays, α-particles, etc. As shown in FIGS. 1A, 1C, and 4A, the high energy radiation is incident directly on the scintillator layer of the detector (or a charge blocking material thereon). The mechanism of absorption of the high energy radiation, generation of carriers, and collection of carriers has been described above and is further described in the Example below: The high sensitivities and high gains of the present detectors renders them useful in a variety of applications such as medical settings, e.g., X-ray imaging, in which the intensity of the X-rays is kept below a value considered harmful to humans. Other applications include aerospace settings, in which the intensity of the high energy radiation may be extremely low, including requiring detection of single photons or single particles.

### Example

### Introduction

This Example reports on novel X-ray detectors based on colloidal quantum dots (QDs)/graphene heterostructures. In some detectors, the heterostructures further include metal halide perovskite (MHP) nanocrystals (NCs). Materials used include CsPbCl₃ NCs (dimension˜10-12 nm) and PbS QDs (diameter˜10-12 nm) which both contain a high-Z element, Pb, for high X-ray stopping power. The QDs/graphene heterostructure in the detectors provides a high photoconductive gain that enables high X-ray sensitivity. Two kinds of QDs/graphene-based detectors were constructed using layer-by-layer inkjet printing of CsPbCl₃ NCs (about 100 nm to 200 nm in thickness), poly (methyl methacrylate) (PMMA) (about 120 nm in thickness), and PbS QDs (about 100 nm in thickness) on graphene with pre-fabricated electrodes. One detector included PMMA/CsPbCl₃ NCs/PMMA/PbS QDs/graphene and another included PMMA/PbS QDs/graphene. High X-ray sensitivities of about 1.70×10³ C/Gy·cm² and 7.05×10² C/Gy·cm², respectively, were obtained for the two types of detectors. These sensitivities are orders of magnitude higher than those reported for devices based on only metal halide perovskites. (For example, an existing X-ray photodetector based on CsPbBr₃ was reported to have a sensitivity of only 1.45×10³ μC/Gy·cm². (Liu, Jingying, et al. Advanced Materials 31.30 (2019): 1901644.)) The improvement in sensitivity is related to the high gain enabled by the QDs/graphene heterostructure. In addition, similar X-ray sensitivity has been demonstrated for PMMA/CsPbCl₃ NCs/PMMA/PbS QDs/graphene detectors made on polyethylene terephthalate (PET) substrates, illustrating an additional advantage as such flexible detectors may be used in curved X-ray detector applications.

### Methods

Chemical and Materials. Lead (II) chloride (PbCl₂, 99.999% trace metals basis), Cesium Carbonate (Cs₂CO₃, 99%), Lead (II) acetate trihydrate (≥99.99%), Hexamethyldisilathiane (HMS). 1-Octadecene (ODE, 90%). Oleylamine (OLA. 70%). Oleic Acid (OA, 90%), Trioctylphosphine (TOP, 90%), Acetone and Hexane (anhydrous. 95%) were bought from Sigma-Aldrich and used without further treatment.

CsPbCl₃ NCs synthesis. CsPbCl₃ NCs were synthesized as follows. Briefly, Cs₂CO₃ (0.814 g) was put into a 100 mL round-bottom three-neck flask containing OA (2.5 mL) and ODE (40 mL), and degassed for 20 min at room temperature and then increased to 120° C. under an Ar flow with a magnetic stir bar stirring for 1 h to exclude the moisture in the reaction reagent. In another round-bottom three-neck flask, PbCl₂ (0.104 g) was put into a mixture solution with OA (1 mL), OLA (1 mL), TOP (2 mL) and ODE (10 mL), and subjected to cycles of vacuum degas/Ar refill at room temperature for 20 min. The temperature was then increased to 120° C. under an Ar flow with a magnetic stir bar stirring for 1 h to exclude moisture. Then the temperature was increased to 150° C. The Cs-oleate precursor solution (0.8 mL) was then injected rapidly into the Pb based precursor at 150° C. After 10 s, the reaction was quickly quenched by cooling to 0° C. using an ice-water mixture bath, resulting in monodisperse CsPbCl₃ NCs with an average size around 10.5 nm. The NCs were recovered by centrifugation at 11.000 rpm for 10 min and cleaned using Methyl acetate (MeOAc)/Hexane mixture solution. The final NCs were stored in a N₂ environment in a glovebox.

PbS QDs. Lead (II) acetate trihydrate (760 mg) was put into oleic acid (OA, 1.4 mL) in a round-bottom three-neck flask and subjected to cycles of vacuum degas/Ar refill for 20 mins in Schlenk line system. Then, 1-Octadecene (ODE, 20 mL) was added and subjected to cycles of vacuum degas/Ar refill for 10 minutes. Then, the temperature was raised to 100° C. under Argon atmosphere. In another round-bottom three-neck flask, hexamethyldisilathiane (HMS. 180 mg) was injected into ODE (10 mL), which was subjected to cycles of vacuum degas and Argon refill for 10 mins while the temperature was stabilized at 100° C. The temperature of the lead acetate trihydrate solution was increased to 130° C. and the HMS degassed mixture solution was quickly injected and reacted for 5 mins. The reaction was allowed to cool down to room temperature. The PbS QDs were precipitated via the addition of acetone, followed by centrifugation. The PbS QDs were purified by three successive dispersions in hexane, precipitated with the help of antisolvents of acetone/ethanol (4:1 volume ratio), and finally dispersed in chloroform.

Hybrid X-ray Photodetector Fabrication. Commercial Si/SiO₂ (90 nm) wafers and PET substrates were used as the substrates. Monolayers of graphene were grown using chemical vapor deposition and transferred onto the desired substrate. Patterned Au (80) nm)/Ti (2 nm) bars were used as source and drain contact electrodes which were deposited onto the graphene monolayers via an electron-beam evaporator under high vacuum 1.0×10⁻⁷ Torr, followed by lift-off. The CsPbCl₃ NCs (5 mg/mL) and PbS QDs (10 mg/mL) dissolved in hexane via sonication were used as the printing inks and printed onto the graphene channels defined by the patterned electrodes by using an inkjet microplotter (SonoPlot. Inc.).

CsPbCl₃ NCs and PbS QDs Surface Engineering. The surface of as-synthesized CsPbCl₃ NCs and PbS QDs were encapsulated by a layer of insulating long carbon chains length molecular OA/OLA, which was effectively replaced by short and highly conductive molecules of 3-mercaptopropionic acid (MPA). A processing solution was prepared by dissolving and mixing MPA in methanol (50% v/v) in a glove box. The fabricated CsPbCl₃/PMMA/PbS devices were dipped into the processing solution for different times in the range of 30-120 s at room temperature. The residual processing solution on the surface of the devices was washed away by methanol. The final devices were stored in glovebox and dried about 10 min before characterization.

Optical and Optoelectronic Characterization. Absorption properties were characterized on a UV-3600 Shimadzu. The morphology of CsPbCl₃ NCs and PbS QDs were evaluated using a field emission FEI Tecnai F20XT. Optical photos of CsPbCl₃ NCs/PMMA/PbS/devices were taken using an optical microscope (Nikon Eclipse LV 150). Optoelectronic properties were tested and recorded via a semiconductor device analyzer (Agilent B1505A). A xenon lamp with a monochromator system (Newport) provided a tunable light source for the device characterization. The instant power density absorbed by the active layer of the devices was calibrated and recorded by a certified Newport power meter. The X-ray source was provided by an X-ray apparatus (554800). The noise signal of the photodetectors was tested via a spectrum analyzer (Stanford Research SR 760).

### Results and Discussion

FIGS. 1A-1B show a schematic of a solution-processed PbS QDs/graphene heterostructure X-ray detector. In the QDs/graphene heterostructure, photoexcited electrons in the conduction band of PbS QDs transfer to the underlying graphene due to the interfacial electric field created by Fermi level alignment, resulting variation of the graphene channel conductance upon irradiation. The photoconductive gain is proportional to the ratio of the carrier lifetime of QDs and the electron transit time of graphene. The strong quantum confinement produced by highly crystalline PbS QDs results in prolonged carrier lifetime, which, in combination with the high charge mobility and extremely short electron transit time of graphene, affords the heterostructures with high photoconductive gain.

FIGS. 1C-1D show another hybrid structure that further includes CsPbCl₃ NCs in the heterostructure. In this detector, high energy (kiloelectronvolt-scale) X-ray photons are absorbed by the top perovskite layer and down converted to numerous low-energy visible photons by direct bandgap emissions. These down converted visible photons are further absorbed by the underlying PbS QDs layer, which subsequently generates electrons as carriers, followed by transfer to graphene, resulting in a detected electronic signal. Compared to the pure PbS QDs/graphene hybrid X-ray photodetectors, the double layer design takes advantage of the highly efficient energy down conversion capacity of the lead halide perovskite nanocrystals.

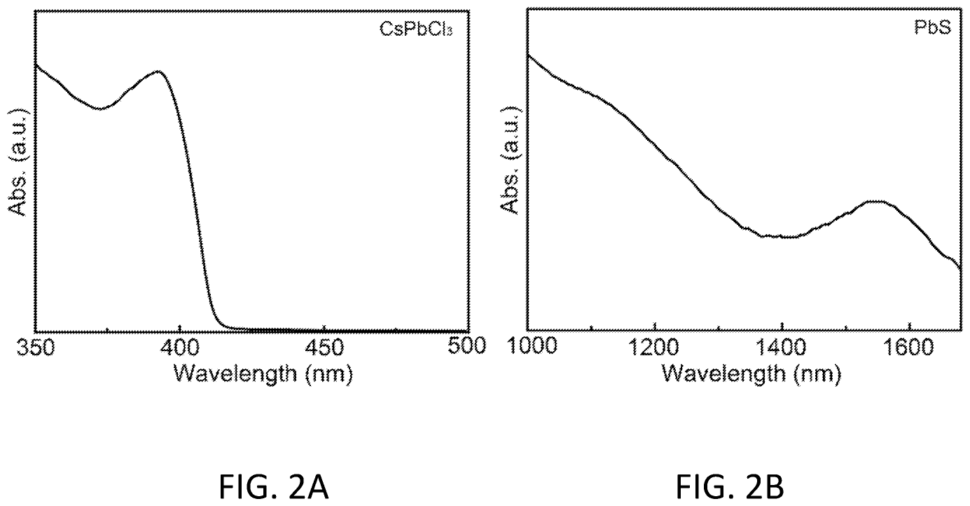

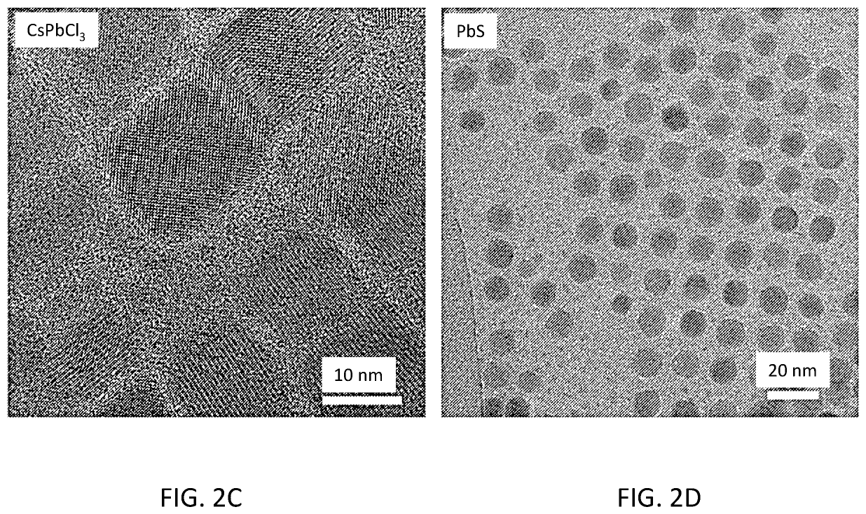

FIGS. 2A-2B plot the UV-visible absorption spectra of the CsPbCl₃ NCs and PbS QDs, respectively. The absorption peaks are located at 392 nm and 1550 nm, respectively. FIG. 2C shows the transmission electron microscopy (TEM) images for the CsPbCl₃ NCs, showing that the NCs have an approximately cubic structure with an average side edge size of 10.3 nm. The inset is a high-resolution TEM (HRTEM) image of an NC showing lattice-fringes of 0.39 nm, corresponding to the expected crystal plane of (110). The regular cubic shape and clear lattice-fringes confirms the high crystal quality of the CsPbCl₃ NCs, which is critical to energy down version conversion. FIG. 2D shows the TEM and HRTEM images of the PbS QDs. The lattice fringe of the PbS QDs is 0.29 nm, matching well with the (200) lattice plane of PbS crystals. Based on the statistics on TEM images, the average diameter of the PbS QDs is around 11.0 nm.

To evaluate the suitability of the hybrid structures as X-ray detectors, the structures were placed in the X-ray characterization system shown in FIG. 3A (see “detector”). The X-ray source was provided by an X-ray apparatus 554800 and controlled by a shutter. The tested detector was connected to a photon-to-electron conversion characterization system, which collected the electronic signals produced by the detector under X-ray irradiation from the X-ray source. FIG. 3B shows a schematic of a portion of the detectors, showing five spaced apart bars of Au/Ni electrodes and an overlying layer of graphene. The graphene between adjacent electrodes forms graphene channels, each having a width of about 866 μm. The dynamic photoresponses were evaluated for both types of detectors, one based on PMMA/PbS QDs/graphene and the other based on PMMA/CsPbCl₃ NCs/PMMA/PbS QDs/graphene. The profound effect of the CsPbCl₃ NCs on the performance of the devices is demonstrated by the enhanced photocurrent (Iₚₕₒₜₒ=I_{irradiation}−I_{durk}). For the X-ray detector based on PMMA/PbS QDs/graphene, the photocurrent is 0.14 μA, corresponding to sensitivity of 7.05×10² C/Gy·cm². The double layer device also including CsPbCl₃ NCs exhibits a much-enhanced performance with photocurrent of 0.23 μA and sensitivity of 1.22×10³ C/Gy·cm².

FIG. 4A illustrates the mechanism of X-ray detection in the MHP NCs/QDs/graphene X-ray detectors. The photoconductive gain (proportional to t_{exciton}/tₜᵣₐₙₛᵢₜ) is defined as the number ratio of the measured electrons and the incident photons on PbS QDs. The high gain of 8.8×10⁵ is the consequence of the strong quantum confinement in QDs that leads to enhanced exciton life time t_{exciton} and the high conductivity in graphene that leads to extraordinary charge carrier mobility and hence, extremely short electron transit time tₜᵣₐₙₛᵢₜ between source and drain electrodes. In the hybrid structure of PMMA/CsPbCl₃ NCs/PMMA/PbS/graphene, the CsPbCl₃ NCs act as a scintillator layer that absorbs X-ray photons and undergoes the scintillation process involving photon to carrier conversion, transport, and luminescence. (The scintillation process described below is applicable to inorganic scintillators.) During the first stage, incoming high energy X-ray radiation interacts with the high Z—Pb atoms, generating hot electrons and deep holes. For radiation energies below 1 MeV, the photoelectric effect and Compton scattering effect dominate this conversion stage. For radiation energies above 1.02 MeV, the pair production mechanism also partially donates to carrier generation. In addition, Auger processes and electron-electron scattering also generate amounts of secondary electrons as charge carriers with lower kinetic energy. Subsequently, the excess kinetic energy of these charge carriers is thermally dissipated by interacting with phonons. Meanwhile, numerous low-kinetic energy electrons and holes progressively accumulate at the conduction band and valence band, respectively. The conversion process occurs on the sub-picosecond time scale.

Next, a tremendous number of electrons and holes are involved in the second stage of the scintillation process which generally occurs on a time scale of 10⁻¹² to 10⁻⁸ s. In this stage, some electrons and holes are captured by defects or other trap states and dissipated. The other surviving electrons and holes complete the recombination radiation process, emitting light having lower wavelengths, generally within the ultraviolet-visible-near infrared (UV-vis-NIR) range, depending on the composition of the MHP NCs. After the scintillation process is completed in the layer of CsPbCl₃ NCs, the emitted light is absorbed in the underlying layer of PbS QDs, in which photon to electron conversion occurs, followed by charge transfer to graphene and collection by the source and drain electrodes.

As shown in FIG. 4B, compared to the pure PbS QDs/graphene X-ray detector (Sample S1), the hybrid scintillator-detectors exhibit greater sensitivity (Samples S2-S4 and other samples, not shown). Specifically, sensitivities of up to 1.70×10³ C/Gy·cm² were obtained for the hybrid PMMA/CsPbCl₃ NCs/PMMA/PbS QDs/graphene detectors. This is an increase of 141% as compared to the PbS QDs/graphene detector (7.05×10² C/Gy·cm³).

The solution processed nanocrystals and the adaptability of graphene enable flexible hybrid CsPbCl₃ NCs/PbS QDs/graphene X-ray detectors, which are important in applications such as medical imaging as they allow for conformal X-ray imaging arrays. To verify this, the hybrid PMMA/CsPbCl₃ NCs/PMMA/PbS QDs/graphene detectors were also fabricated and tested on transparent and flexible PET substrates. FIG. 5A plots the I-V curves of this hybrid X-ray detector under dark and under X-ray irradiation conditions, demonstrating the resistance behavior of the graphene channel and ohmic contact between the graphene and electrodes. FIG. 5B is a zoomed-in portion of FIG. 5A to show the difference between the dark and X-ray irradiation conditions. The photocurrent and X-ray sensitivity reach 10.7 μA and 5.59×10³ C/Gy·cm² under X-ray irradiation at a bias voltage of 1.0 V. FIG. 5C shows a schematic image of a detector array on a flexible PET substrate. Each detector in the array has the hybrid PMMA/CsPbCl₃ NCs/PMMA/PbS QDs/graphene structure. As shown in FIG. 5D, the flexible detector array is extremely stable as the I-V curve after 20 times bending is identical to the I-V curve before bending.

### CONCLUSION

In summary, this Example has demonstrated X-ray detection using QDs/graphene heterostructures for both high sensitivity and low cost. The fabricated detectors are quantum devices having high photoconductive gains up to 10¹⁰ enabled by strong quantum confinement in QDs with enhanced light-solid interaction and graphene with superior charge carrier mobility. Detectors having both sphere-shaped PbS QDs of diameter ˜10-12 nm and cubic-shaped metal halide perovskite CsPbCl₃ NCs of edge size ˜10-12 nm were fabricated. Layer-by-layer inkjet printing of CsPbCl₃ QDs (about 100 nm to 200 nm in thickness), PMMA (about 120 nm in thickness), and PbS QDs (about 100 nm in thickness) on graphene having pre-fabricated electrodes thereon and disposed over rigid SiO₂/Si or flexible PET substrates was used to fabricate detectors. High X-ray sensitivities of about 7.05×10² C/Gy·cm² and 1.70>10³ C/Gy·cm², respectively, were achieved for PMMA/PbS QDs/graphene detectors and for PMMA/CsPbCl₃ NCs/PMMA/PbS QDs/graphene detectors. In addition, a comparable X-ray sensitivity of 5.59×10³ C/Gy·cm² was achieved for PMMA/CsPbCl₃ NCs/PMMA/PbS QDs/graphene detectors formed on flexible PET substrates. The sensitivities are several orders of magnitude higher than existing X-ray photodetectors based on metal halide perovskite single crystals, nanocrystals, and polycrystalline films, illustrating the advantage of high photoconductive gain by using QDs/graphene heterostructures.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more.”

All numeric values of parameters in the present disclosure are proceeded by the term “about” which means approximately. This encompasses those variations inherent to the measurement of the relevant parameter as understood by those of ordinary skill in the art. This also encompasses the exact value of the disclosed numeric value and values that round to the disclosed numeric value.

The foregoing description of illustrative embodiments of the disclosure has been presented for purposes of illustration and of description. It is not intended to be exhaustive or to limit the invention to the precise form disclosed, and modifications and variations are possible in light of the above teachings or may be acquired from practice of the disclosure. The embodiments were chosen and described in order to explain the principles of the disclosure and as practical applications of the disclosure to enable one skilled in the art to utilize the disclosure in various embodiments and with various modifications as suited to the particular use contemplated. It is intended that the scope of the disclosure be defined by the claims appended hereto and their equivalents.

What is claimed is:

1. A method of detecting high energy radiation, the method comprising:
(a) exposing a detector to a source of high energy radiation, the detector comprising
a scintillator layer comprising a metal halide perovskite:
a charge generation layer comprising semiconductor quantum dots, the charge generation layer positioned between the scintillator layer and a charge transport layer comprising graphene, the charge generation layer forming an interface with the charge transport layer;
the charge transport layer comprising graphene; and
electrodes in electrical communication with the charge transport layer; and
(b) collecting carriers from the charge transport layer, the carriers generated in the charge generation layer via absorption of the high energy radiation in the scintillator layer.

2. The method of claim 1, wherein the high energy radiation has an energy per photon or energy per particle of at least 1 keV.

3. The method of claim 1, wherein the high energy radiation is X-ray radiation, gamma ray radiation, or α-particle radiation.

4. The method of claim 1, wherein the metal halide perovskite is in a form of nanocrystals.

5. The method of claim 1, wherein the scintillator layer has a thickness of no more than 500 nm.

6. The method of claim 1, wherein the metal halide perovskite has Formula IA, APbX₃, wherein A is selected from alkali metals and X is selected from halogens.

7. The method of claim 6, wherein the metal halide perovskite has Formula IB, CsPbX₃.

8. The method of claim 1, wherein the semiconductor quantum dots are composed of PbS.

9. The method of claim 1, wherein the detector further comprises a layer of a charge blocking material between the scintillator layer and the charge generation layer.

10. The method of claim 1, wherein the electrodes are positioned such that an electric field generated by a bias voltage applied to the electrodes is oriented parallel to planes defined by the scintillator layer, the charge generation layer, and the charge transport layer.

11. The method of claim 10, wherein the electrodes are positioned on the same surface of the charge transport layer.

12. The method of claim 1, wherein the scintillator layer consists of the metal halide perovskite, the charge generation layer consists of the semiconductor quantum dots, and the charge transport layer consists of the graphene.

13. The method of claim 12, wherein the metal halide perovskite is CsPbCl₃ in a form of nanocrystals and the semiconductor quantum dots are composed of PbS.

14. The method of claim 13, wherein the detector comprises one or more active regions, each active region consisting of the scintillator layer, the charge generation layer, the charge transport layer, the electrodes, and optionally, one or more layers of a charge blocking material.

15. The method of claim 1, wherein the detector is characterized by a sensitivity to X-ray radiation of at least 1.5×10³ C/Gy·cm².

16. A high energy radiation detector, the detector comprising:
a scintillator layer comprising a metal halide perovskite:
a charge generation layer comprising semiconductor quantum dots, the charge generation layer positioned between the scintillator layer and a charge transport layer comprising graphene, the charge generation layer forming an interface with the charge transport layer:
the charge transport layer comprising graphene; and
electrodes in electrical communication with the charge transport layer.

17. The detector of claim 16, wherein the electrodes are positioned such that an electric field generated by a bias voltage applied to the electrodes is oriented parallel to planes defined by the scintillator layer, the charge generation layer, and the charge transport layer.

18. The detector of claim 16, wherein the scintillator layer consists of the metal halide perovskite, the charge generation layer consists of the semiconductor quantum dots, and the charge transport layer consists of the graphene.

19. The detector of claim 18, wherein the metal halide perovskite is CsPbCl₃ in a form of nanocrystals and the semiconductor quantum dots are composed of PbS.

20. The detector of claim 19, wherein the detector comprises one or more active regions, each active region consisting of the scintillator layer, the charge generation layer, the charge transport layer, the electrodes, and optionally, one or more layers of a charge blocking material.
